(19) United States
(12) Patent Application Publication
(10) Pub. No.: US 2024/0154561 A1
(43) Pub. Date: May 9, 2024

(54) INVERTER CONTROL DEVICE AND PROGRAM

(71) Applicant: DENSO CORPORATION, Kariya-city (JP)

(72) Inventors: Harumi HORIHATA, Kariya-city (JP); Yasuaki AOKI, Kariya-city (JP); Takahiro WATANABE, Kariya-city (JP)

(73) Assignee: DENSO CORPORATION, Kariya-city (JP)

(21) Appl. No.: 18/403,021

(22) Filed: Jan. 3, 2024

Related U.S. Application Data
(63) Continuation of application No. PCT/JP22/23489, filed on Jun. 10, 2022.

(30) Foreign Application Priority Data
Jul. 8, 2021 (JP) 2021-113473

(51) Int. Cl. H02P 27/08; H02P 25/022; H02P 101/45

(52) U.S. Cl. CPC H02P 27/08; H02P 25/022; H02P 2101/45

(57) ABSTRACT

An inverter control device is for a vehicle including: a rotating electric machine that is an in-wheel motor integrated inside a drive wheel and includes a rotor including a magnet portion with a plurality of magnetic poles and a stator including multiphase stator windings without teeth protruding radially toward the rotor; and an inverter electrically connected to the rotating electric machine. The inverter control device includes: a control unit configured to perform PWM control to generate a drive signal for a switching element in the inverter based on a carrier signal and a command voltage in each phase in the overall operating region for an operating point defined by the rotation speed and the torque of the rotating electric machine; and an operation unit configured to operate the switching element based on the generated drive signal.

### CROSS-REFERENCE TO RELATED APPLICATION

This application is the U.S. bypass application of International Application No. PCT/JP2022/023489 filed on Jun. 10, 2022 which designated the U.S. and claims priority to Japanese Patent Application No. 2021-113473 filed on Jul. 8, 2021, the contents of both of which are incorporated herein by reference.

### TECHNICAL FIELD

The present disclosure relates to an inverter control device and a program.

### BACKGROUND

As described in JP 2016-92995 A, there is a conventionally known inverter control device for a vehicle including a rotating electric machine that is an in-wheel motor integrated inside a drive wheel and an inverter electrically connected to the rotating electric machine. The control device controls the operation of switching elements in the inverter. In this case, the control device may perform PWM control based on a carrier signal and a command voltage in each phase of the inverter so as to reduce torque ripple.

### SUMMARY

The present disclosure provides an inverter control device for a vehicle including: a rotating electric machine that is an in-wheel motor integrated inside a drive wheel and includes a rotor including a magnet portion with a plurality of magnetic poles and a stator including multiphase stator windings without teeth protruding radially toward the rotor; and an inverter electrically connected to the rotating electric machine. The inverter control device includes: a control unit configured to perform PWM control to generate a drive signal for a switching element in the inverter based on a carrier signal and a command voltage in each phase in the overall operating region for an operating point defined by the rotation speed and the torque of the rotating electric machine; and an operation unit configured to operate the switching element based on the drive signal.

### BRIEF DESCRIPTION OF THE DRAWINGS

The above features of the present disclosure will be made clearer by the following detailed description, given referring to the appended drawings. In the accompanying drawings:

FIG. 1 is a schematic diagram of an electric vehicle;

FIG. 2 is a perspective view of an in-wheel motor structure;

FIG. 3 is a longitudinal section view of a rotating electric machine;

FIG. 4 illustrates PWM signals in PWM control;

FIG. 5 illustrates a method for generating drive signals based on PWM signals; and

FIG. 6 illustrates an operating region for the operating point of the rotating electric machine.

### DETAILED DESCRIPTION OF THE PREFERRED EMBODIMENTS

In PWM control, when a rotating electric machine is operated in a high torque range and a high rotation speed range, the frequency of the carrier signal may be increased in order to maintain the controllability of the rotating electric machine. However, in this case, the output torque of the rotating electric machine may be limited due to a decrease in the voltage utilization rate. Accordingly, when the rotating electric machine is operated in a high torque range and a high rotation speed range in which the carrier frequency needs to be increased, the implementation of the PWM control may be limited. In this case, there is concern that the torque ripple may increase.

The present disclosure has been made in order to solve the problems, and an objective of the disclosure is to provide an inverter control device and a program that can prevent torque ripple.

The present disclosure provides an inverter control device for a vehicle including: a rotating electric machine that is an in-wheel motor integrated inside a drive wheel and includes a rotor including a magnet portion with a plurality of magnetic poles and a stator including multiphase stator windings without teeth protruding radially toward the rotor; and an inverter electrically connected to the rotating electric machine. The inverter control device includes: a control unit configured to perform PWM control to generate a drive signal for a switching element in the inverter based on a carrier signal and a command voltage in each phase in the overall operating region for an operating point defined by the rotation speed and the torque of the rotating electric machine; and an operation unit configured to operate the switching element based on the drive signal.

Unlike the present disclosure, a stator may include multiple teeth extending radially toward a rotor, with a slot formed between circumferentially adjacent teeth. The slot contains a stator winding. In a stator structure with teeth, when the stator winding is energized, there is concern that the magnetomotive force of the stator winding may increase and cause magnetic saturation in the teeth of the stator, lowering the controllability of the rotating electric machine.

In the present disclosure, no teeth are provided. This configuration may prevent magnetic saturation in teeth, which may reduce the controllability of the rotating electric machine. This enables the rotating electric machine to operate even in a high torque range and a high rotation speed range without increasing the frequency of the carrier signal. As a result, the implementation of PWM control is not limited, thus reducing the occurrence of torque ripple.

A first embodiment of a control device according to the present disclosure will now be described with reference to the drawings. The control device is installed in an electric vehicle.

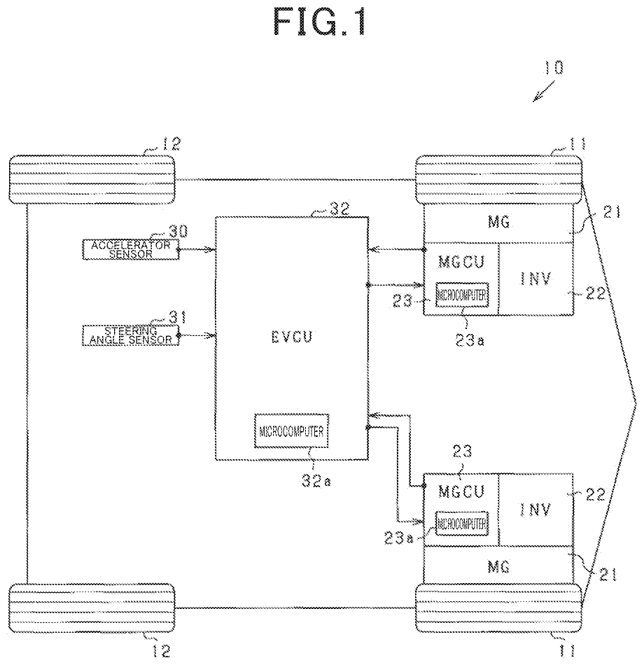

As illustrated in FIG. 1, a vehicle 10 includes right and left front wheels 11, right and left rear wheels 12, and rotating electric machines 21. In the present embodiment, the rotating electric machines 21 are provided individually corresponding to each front wheel 11. The front wheels 11 are thus drive wheels rotatable independently of each other. The rear wheels 12 are trailing wheels driven by the vehicle 10 as it travels.

Each rotating electric machine 21 is an in-wheel motor integrated inside the corresponding drive wheel. The vehicle 10 does not include a transmission (specifically, a reduction gear) for adjusting the ratio between the rotation speed of the rotor and the rotation speed of the drive wheel on the power transmission path between the drive wheel and the rotor of the rotating electric machine 21. Thus, the rotor of the rotating electric machine 21 and the drive wheel have the same rotation speed. The rotating electric machine 21 is a permanent-magnet synchronous motor having a permanent magnet on the rotor. The configuration of the rotating electric machine 21 is described later.

The vehicle 10 includes inverters 22 and MGCUs 23. The inverters 22 and the MGCUs 23 are provided individually corresponding to each rotating electric machine 21. The inverter 22 is a full-bridge circuit including as many upper and lower arms as the phases of the rotating electric machine 21. In the present embodiment, the inverter 22 includes series-connection bodies for three phases each having upper and lower arm switches. The upper and lower arm switches in each phase are turned on alternately with a dead time in between. Each switch is a voltage controlled semiconductor switching element, or specifically, an n-channel MOSFET. Each switch is formed from, for example, a silicon carbide (SiC) material and characterized by a switching speed higher than the switching speed of an IGBT formed from Si. In an example where a switch is turned off, the switching speed refers to the time taken from when the gate voltage starts decreasing to when the gate voltage falls below a threshold voltage Vth. The high switching speed allows the dead time to be shorter, enabling the rotating electric machine 21 to have a higher voltage utilization rate, which is the ratio of the output voltage to the input voltage.

The MGCU 23 is basically a microcomputer 23a (corresponding to a computer), and the microcomputer 23a includes a CPU. The functions provided by the microcomputer 23a may be provided by software recorded on a tangible memory device and a computer for executing it, software alone, hardware alone, or a combination thereof. For example, when provided by an electronic circuit, which is hardware, the microcomputer 23a may be provided by an analog circuit or a digital circuit including a large number of logic circuits. For example, the microcomputer 23a executes programs stored in its non-transitory tangible storage medium serving as a storage unit. The programs include, for example, programs for torque generation control or regenerative control described later. When the programs are executed, the method corresponding to the programs is implemented. The storage unit is, for example, a non-volatile memory. The programs stored in the storage unit can be updated through a network such as the internet.

The MGCU 23 performs torque generation control or regenerative control in order to control the torque of the rotating electric machine 21 to a command torque Trq*. The torque generation control is switching control of the inverter 22 for converting DC power input from a DC power supply (not shown) to the inverter 22 into AC power and supplying the AC power to the rotating electric machine 21. When this control is performed, the rotating electric machine 21 functions as an electric motor and generates power running torque. The regenerative control is switching control of the inverter 22 for converting AC power generated by the rotating electric machine 21 into DC power and supplying the DC power to the DC power supply. When this control is performed, the rotating electric machine 21 functions as an electric generator and generates regeneration torque.

The vehicle 10 includes an accelerator sensor 30, a steering angle sensor 31, and an EVCU 32. The accelerator sensor 30 detects an accelerator stroke, or the amount by which the accelerator pedal as the driver's accelerator operating member is depressed. The steering angle sensor 31 detects the steering angle of the steering wheel operated by the driver. The accelerator sensor 30 and the steering angle sensor 31 input the detection values to the EVCU 32.

The EVCU 32 is basically a microcomputer 32a, and the microcomputer 32a includes a CPU. The functions provided by the microcomputer 32a may be provided by software recorded on a tangible memory device and a computer for executing it, software alone, hardware alone, or a combination thereof. For example, when provided by an electronic circuit, which is hardware, the microcomputer 32a may be provided by an analog circuit or a digital circuit including a large number of logic circuits. For example, the microcomputer 32a executes programs stored in its storage unit. The programs include, for example, programs for the processing of calculating a command rotation speed Nm* and a command torque Trq* and exchanging information with the MGCU 23 as described later. The programs stored in the storage unit can be updated through a network such as the internet.

The EVCU 32 calculates the command rotation speed Nm* of the rotor of the rotating electric machine 21 based on the accelerator stroke detected by the accelerator sensor 30 and the steering angle detected by the steering angle sensor 31. The EVCU 32 calculates the command torque Trq* as the operation amount for feedback-controlling the rotation speed Nm of the rotor of the rotating electric machine 21 to the calculated command rotation speed Nm*. The rotation speed Nm of the rotor of the rotating electric machine 21 may be calculated, for example, based on a detection value from a rotation angle sensor such as a resolver that detects the rotation angle of the rotor of the rotating electric machine 21. For the vehicle 10 having a self-driving function, during the self-driving mode, the EVCU 32 may calculate the command rotation speed Nm*, for example, based on the target traveling speed of the vehicle 10 set by a self-driving CU included in the vehicle 10.

The MGCU 23 and the EVCU 32 can exchange information with each other using a predetermined communication protocol (for example, CAN). This allows the EVCU 32 to transmit the calculated command torque Trq* to the MGCU 23.

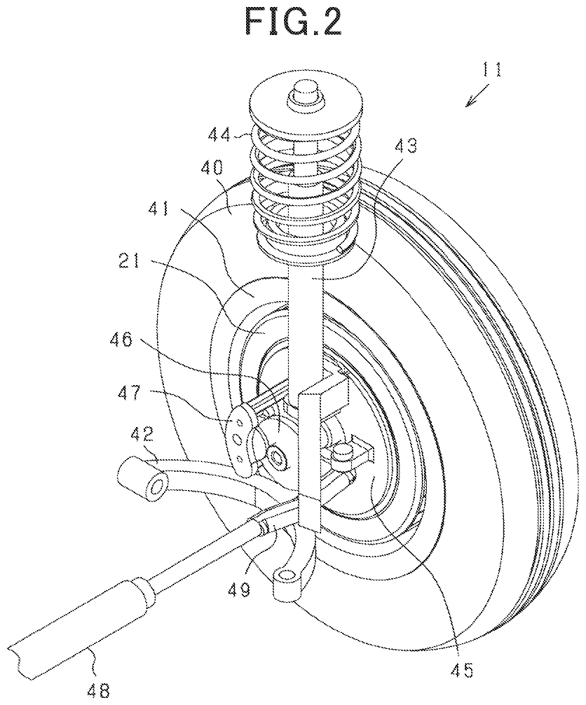

With reference to FIG. 2, the rotating electric machine 21 and its surrounding structure will now be described.

The front wheel 11 includes, for example, a well-known pneumatic tire 40 and a wheel 41 secured inside the tire 40. The rotating electric machine 21 is secured inside the wheel 41. The rotating electric machine 21 includes a stator and a rotor with the stator fixed to the vehicle body and the rotor fixed to the wheel 41, and the rotor rotates to turn the tire 40 and the wheel 41. The configuration of the rotating electric machine 21 including the stator and the rotor is described later.

The front wheel 11 is provided with, as its associated equipment, suspension equipment that holds the front wheel 11 with respect to the vehicle body (not shown), steering equipment that allows the orientation of the front wheel 11 to vary, and brake equipment that slows or stops the front wheel 11.

The suspension equipment is an independent suspension and may be of any type such as a trailing arm, strut, wishbone, or multilink type. In the present embodiment, the suspension equipment includes a lower arm 42 provided in a direction toward the center of the vehicle and a suspension arm 43 and a spring 44 provided in a vertical direction. The suspension arm 43 may be, for example, a shock absorber. The suspension arm 43 and the spring 44 function to reduce vibrations transmitted to the vehicle 10. The lower arm 42 and the suspension arm 43 are both connected to the vehicle body as well as a disc-shaped base plate 45 fixed to the stator of the rotating electric machine 21.

The brake equipment may appropriately be disc brakes or drum brakes. In the present embodiment, the installed brake equipment includes a disc rotor 46 fixed to the rotational shaft of the rotating electric machine 21 and a brake caliper 47 fixed to the base plate 45 on the rotating electric machine 21. The brake caliper 47 has brake pads operated hydraulically, and the brake pads are pressed against the disc rotor 46 to generate a frictional braking force, stopping the rotation of the front wheel 11.

The steering equipment may be, for example, a rack-and-pinion structure, a ball-and-nut structure, a hydraulic power steering system, or an electric power steering system. In the present embodiment, the installed steering equipment includes a rack 48 and a tie rod 49 with the rack 48 connected to the base plate 45 on the rotating electric machine 21 through the tie rod 49. In this case, when the rack 48 operates with the rotation of a steering shaft (not shown), the tie rod 49 moves in the vehicle lateral direction. The movement turns the front wheel 11 about the support shaft of the lower arm 42 and the suspension arm 43 to change the wheel direction.

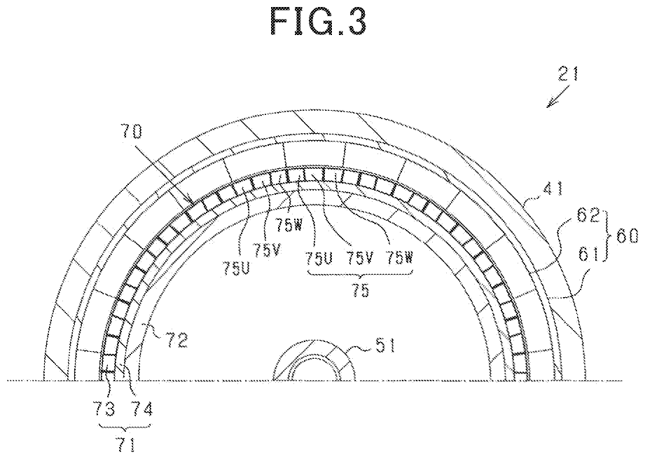

FIG. 3 illustrates the configuration of the rotating electric machine 21 used as an in-wheel motor. The rotating electric machine 21 has an outer rotor structure. In the rotating electric machine 21, the direction in which a rotational shaft 51 extends is an axial direction, the direction extending radially from the center of the rotational shaft 51 is a radial direction, and the direction extending circumferentially around the rotational shaft 51 is a circumferential direction.

The rotating electric machine 21 includes a rotor 60 and a stator unit 70. These components are both located coaxially with the rotational shaft 51 and installed axially in a predetermined order to form the rotating electric machine 21. The rotating electric machine 21 includes radial ball bearings (not shown), and the radial ball bearings include an outer ring, an inner ring, and multiple balls placed between the rings. The outer ring is fixed to the housing (not shown) of the rotating electric machine 21, whereas the inner ring is fixed to the rotational shaft 51.

The rotor 60 includes a rotor carrier 61 and a magnet unit 62. The rotor carrier 61 has a cylindrical portion (not shown), and the cylindrical portion serves as a magnet holding member. The magnet unit 62 is fixed annularly to the radial inside of the cylindrical portion of the rotor carrier 61. The magnet unit 62 has magnets arranged in the circumferential direction of the rotor 60 in a manner that alternates polarities. Accordingly, the magnet unit 62 has a plurality of magnetic poles arranged circumferentially. That is, the rotating electric machine 21 is a surface permanent magnet synchronous motor (SPMSM). The magnet is an anisotropic permanent magnet and formed of, for example, a sintered neodymium magnet having an intrinsic coercive force of 400 [kA/m] or more and a residual magnetic flux density Br of 1.0 [T] or more. In the present embodiment, the magnet unit 62 corresponds to a magnet portion.

The cylindrical portion of the rotor carrier 61 has an end plate (not shown) at one end thereof. The end plate of the rotor carrier 61 is fixed to the rotational shaft 51. The front wheel 11 is fixed to the rotational shaft 51. The rotor 60 and the rotational shaft 51 rotate to turn the wheel 41 and the tire 40.

In the rotating electric machine 21, the stator unit 70 surrounds the rotational shaft 51, and the rotor 60 is located radially outside the stator unit 70. The stator unit 70 includes a stator 71 and a stator holder 72 mounted on its radial inside. The stator holder 72 is cylindrical and formed from, for example, a soft magnetic material such as cast iron or a non-magnetic material such as aluminum or carbon fiber reinforced plastics (CFRP). The rotor 60 and the stator 71 face each other in the radial direction with an air gap in between, and the rotor 60 rotates radially outside the stator 71.

The stator 71 includes a stator winding 73 and a stator core 74. The stator 71 has an axial part corresponding to the coil side facing the rotor 60 in the radial direction and a part corresponding to the coil end, which is the axial outside of the coil side. In this case, the stator core 74 is provided in the axial range corresponding to the coil side.

The stator winding 73 includes multiple phase windings and has a cylindrical shape formed by placing the phase windings in the respective phases circumferentially in a predetermined order. In the present embodiment, the stator winding 73 includes phase windings in three phases: the U-phase, the V-phase, and the W-phase. The phase windings in the respective phases are star connected to each other with one end connected to the connection point between the upper and lower arm switches and the other end connected to a neutral point. The phase windings in the respective phases may be delta connected.

The stator winding 73 in each phase includes conductors 75 extending in the axial direction and placed in the range covering the coil side, and bridges that connect circumferentially adjacent conductors 75 in the same phase. FIG. 3 illustrates the order of the U-phase, V-phase, and W-phase conductors 75U, 75V, and 75W arranged on the coil side.

The stator core 74 is a core sheet stack obtained by axially layering core sheets made of electromagnetic steel plates, or magnetic substances, and has a cylindrical shape with a predetermined radial thickness. The stator winding 73 is mounted on the radial outside of the stator core 74 facing the rotor 60. The stator core 74 has a smooth and curved outer surface. The stator core 74 functions as a back yoke. The stator core 74 is, for example, an axial stack of multiple core sheets formed by punching into annular plates. However, the stator core 74 may have a helical core structure made of a belt-shaped core sheet.

In the present embodiment, the stator 71 has a slotless structure without teeth for forming slots and may have any of the configurations described below as (A) to (C).
(A) The stator 71 includes inter-conductor members provided circumferentially between the conductors 75, and the inter-conductor members are magnetic materials satisfying: Wt×Bs≤Wm×Br, where Wt denotes the circumferential width of inter-conductor members per magnetic pole, Bs denotes the saturation magnetic flux density of the inter-conductor members, Wm denotes the circumferential width of magnets per magnetic pole, and Br denotes the residual magnetic flux density of the magnets.
(B) The stator 71 includes inter-conductor members provided circumferentially between the conductors 75, and the inter-conductor members are non-magnetic materials.
(C) The stator 71 includes no inter-conductor members provided circumferentially between the conductors 75.

The torque generation control and the regenerative control performed by the MGCU 23 will now be described. In the torque generation control and the regenerative control, the MGCU 23 performs PWM control to generate drive signals GUH, GUL, GVH, GVL, GWH, and GWL for the switches in the inverter 22. The MGCU 23 calculates the command voltage in each phase based on the command torque Trq* received from the EVCU 32. The MGCU 23 generates PWM signals GU, GV, and GW in the respective phases based on the comparison between the carrier signal and the calculated command voltage in each phase.

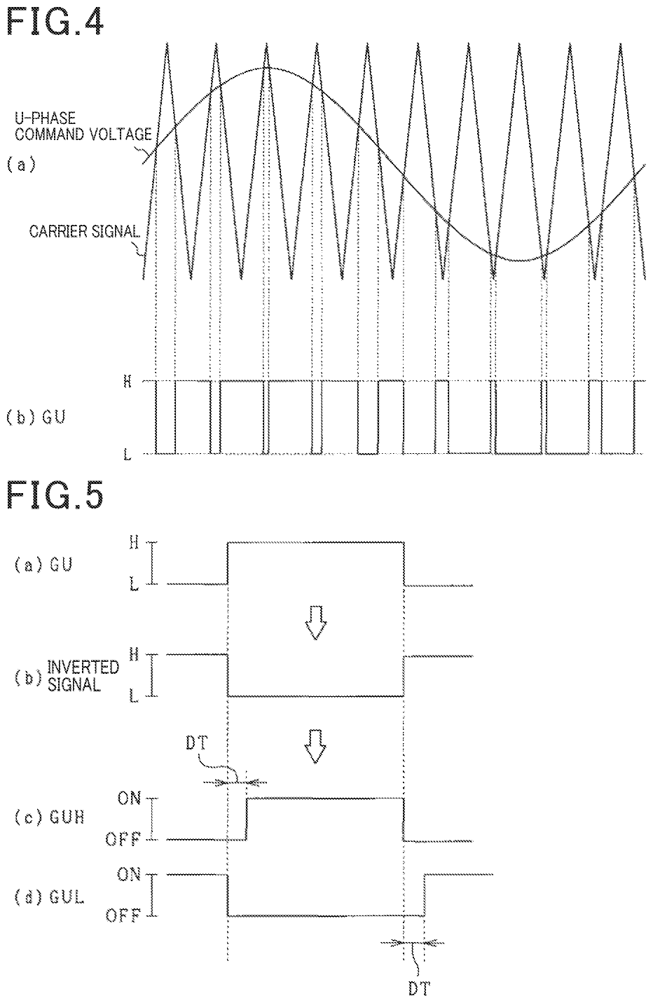

For example, as illustrated in FIG. 4, the MGCU 23 generates the U-phase PWM signal GU based on the comparison between the carrier signal and the sinusoidal U-phase command voltage. In the present embodiment, the PWM control performed is sinusoidal PWM control with the amplitude of the U-phase command voltage equal to or lower than the amplitude of the carrier signal. The U-phase PWM signal GU represents logic H when the command voltage is higher than the carrier signal, or represents logic L when the command voltage is lower than the carrier signal. The MGCU 23 generates the PWM signals GV and GW respectively for the V-phase and the W-phase in the same manner as in the U-phase.

The MGCU 23 generates the drive signals GUH, GUL, GVH, GVL, GWH, and GWL for the switches based on the generated PWM signals GU, GV, and GW. The drive signals GUH, GUL, GVH, GVL, GWH, and GWL are transmitted for the upper and lower arm switches to control the turning on and off of each switch.

For example, as illustrated in FIG. 5, the MGCU 23 inverts the logic of the U-phase PWM signal GU to generate an inverted signal. The MGCU 23 separates the logic inverting times of the U-phase PWM signal GU and the inverted signal from each other by a dead time DT to generate the U-phase drive signals GUH and GUL. In the same manner as in the U-phase, the MGCU 23 also generates the drive signals GVH, GVL, GWH, and GWL for the V-phase and the W-phase. FIG. 5(a) shows changes in the U-phase PWM signal GU, FIG. 5(b) shows changes in the inverted signal, and FIGS. 5(c) and 5(d) show changes in the U-phase drive signals GUH and GUL for the upper and lower arms. In the present embodiment, the MGCU 23 corresponds to a control unit and an operation unit.

In PWM control, when the rotating electric machine 21 is operated in a high torque range and a high rotation speed range, the frequency of the carrier signal may be increased in order to maintain the controllability of electric currents flowing through the stator winding 73. However, in this case, the output torque of the rotating electric machine 21 may be limited due to a decrease in the voltage utilization rate. Accordingly, when the rotating electric machine 21 is operated in a high torque range and a high rotation speed range in which the carrier frequency needs to be increased, the implementation of the PWM control may be limited. In this case, although the voltage utilization rate may be increased by performing rectangular wave control instead of the PWM control, there is concern that the torque ripple may increase.

In the present embodiment, the vehicle 10 includes no transmission on the power transmission path between the drive wheel and the rotor 60 of the rotating electric machine 21. Thus, there is concern that the torque ripple may tend to increase because the rotating electric machine 21 is likely to have a lower rotation speed Nm.

In the present embodiment, the rotating electric machine 21 is located inside the wheel 41 with the rotational shaft 51 of the rotating electric machine 21 extending in the lateral direction of the vehicle 10, and the suspension equipment is secured to the stator 71 and extends in the vertical direction of the vehicle 10. Thus, there is concern that vibrations caused by the rotating electric machine 21 producing torque ripple and vibrations produced during a drive may be combined and adversely affect the ride comfort of the vehicle 10.

To reduce the concerns, the stator 71 in the rotating electric machine 21 according to the present embodiment includes no teeth. This configuration may prevent magnetic saturation in teeth, which may reduce the controllability of the rotating electric machine 21. This enables the rotating electric machine 21 to operate even in a high torque range and a high rotation speed range without increasing the frequency of the carrier signal.

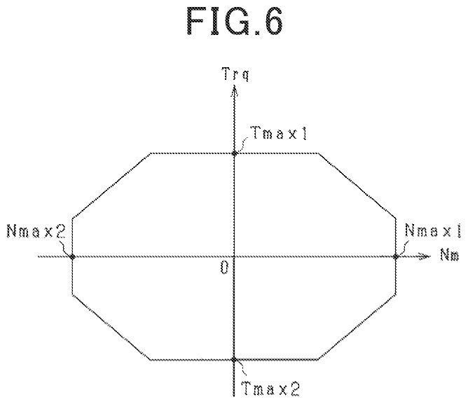

FIG. 6 illustrates an operating region for the operating point defined by the rotation speed Nm and the torque Trq of the rotating electric machine 21. The operating region includes a continuous operating region in which the rotating electric machine 21 and the inverter 22 can be continuously driven and a short-time operating region temporarily used when the vehicle 10 accelerates or decelerates. In FIG. 6, when the torque Trq has a positive value, the torque generation control is performed, whereas when the torque Trq has a negative value, the regenerative control is performed. Tmax1 denotes the maximum value of the torque Trq during the torque generation control, whereas Tmax2 denotes the maximum value of the torque Trq during the regenerative control. The maximum values Tmax1 and Tmax2 of the torque Trq denote the maximum values of the torque Trq applied to the rotor 60 when the vehicle 10 accelerates and decelerates, respectively.

When the rotation speed Nm has a positive value, the vehicle 10 moves forward, whereas when the rotation speed Nm has a negative value, the vehicle 10 moves backward. Nmax1 denotes the maximum value of the rotation speed Nm when the vehicle 10 moves forward, whereas Nmax2 denotes the maximum value of the rotation speed Nm when the vehicle 10 moves backward. The maximum values Nmax1 and Nmax2 of the rotation speed Nm denote the maximum rotation speeds Nm of the rotor 60.

The MGCU 23 performs PWM control in the overall operating region for the operating point illustrated in FIG. 6. In other words, the MGCU 23 does not perform rectangular wave control that turns on the upper and lower arm switches once each in one electrical angle cycle. This may reduce the occurrence of torque ripple and thus prevent adverse effects on the ride comfort of the vehicle 10.

### OTHER EMBODIMENTS

The PWM control may be overmodulation PWM control instead of sinusoidal PWM control. The overmodulation PWM control is switching control that generates the PWM signals GU, GV, and GW in the respective phases based on the comparison between the carrier signal and the command voltage in each phase having an amplitude higher than the amplitude of the carrier signal.

The rotating electric machine 21 may be provided individually corresponding not to each front wheel 11 but for the rear wheels 12 or may be provided individually corresponding to each front wheel 11 and the rear wheel 12.

The vehicle 10 may not have four wheels but may have, for example, three or five or more wheels.

The rotating electric machine 21 may have an inner rotor structure instead of the outer rotor structure.

The rotating electric machine 21 may be an interior permanent magnet synchronous motor (IPMSM) instead of the surface permanent magnet synchronous motor.

Each switch of the inverter 22 may be an IGBT formed from Si instead of the n-channel MOSFET formed from SiC materials.

The control unit and its techniques described in the present disclosure may be implemented by a special purpose computer including memory and a processor programmed to execute one or more functions embodied by computer programs. Alternatively, the control unit and its technique described in the present disclosure may be implemented by a special purpose computer including a processor having one or more dedicated hardware logic circuits. Alternatively, the control unit and its technique described in the present disclosure may be implemented by one or more special purpose computers including a combination of memory and a processor programmed to execute one or more functions and a processor having one or more hardware logic circuits. The computer programs may be stored in a non-transitory, tangible computer readable storage medium as instructions executed by a computer.

Although the present disclosure has been described in accordance with the embodiments, it will be understood that the disclosure is not limited to the embodiments or the structures. The disclosure encompasses various modifications and alterations falling within the range of equivalence. Additionally, various combinations and forms as well as other combinations and forms with one, more than one, or less than one element added thereto also fall within the scope and spirit of the present disclosure.

What is claimed is:

1. An inverter control device for a vehicle, the vehicle including:
a rotating electric machine that is an in-wheel motor integrated inside a drive wheel and includes:
a rotor including a magnet portion with a plurality of magnetic poles, and
a stator including multiphase stator windings without teeth protruding radially toward the rotor, and
an inverter electrically connected to the rotating electric machine, the inverter control device comprising:
a control unit configured to perform PWM control to generate a drive signal for a switching element in the inverter based on a carrier signal and a command voltage in each phase in an overall operating region for an operating point defined by rotation speed and torque of the rotating electric machine; and
an operation unit configured to operate the switching element based on the generated drive signal.

2. The inverter control device according to claim 1, wherein
the inverter control device does not include a transmission for adjusting a ratio between rotation speed of the rotor and rotation speed of the drive wheel on a power transmission path between the rotor and the drive wheel.

3. The inverter control device according to claim 1, wherein
the rotating electric machine is located inside the drive wheel with a rotational shaft of the rotating electric machine extending in a lateral direction of the vehicle, and
the vehicle includes suspension equipment secured to the stator and extending in a vertical direction.

4. The inverter control device according to claim 2, wherein
the rotating electric machine is located inside the drive wheel with a rotational shaft of the rotating electric machine extending in a lateral direction of the vehicle, and
the vehicle includes suspension equipment secured to the stator and extending in a vertical direction.

5. A program for a vehicle, the vehicle including:
a rotating electric machine that is an in-wheel motor integrated inside a drive wheel and includes:
a rotor including a magnet portion with a plurality of magnetic poles, and
a stator including multiphase stator windings without teeth protruding radially toward the rotor,
an inverter electrically connected to the rotating electric machine, and
a computer, the program causing the computer to perform:
PWM control processing to generate a drive signal for a switching element in the inverter based on a carrier signal and a command voltage in each phase in an overall operating region for an operating point defined by rotation speed and torque of the rotating electric machine; and
the switching element operation processing based on the drive signal.
